(19) United States
(12) Patent Application Publication
(10) Pub. No.: US 2005/0120103 A1
(43) Pub. Date: Jun. 2, 2005

(54) Method and graphical user interface (GUI) for multiple managed objects(MOs) viewing and editing

(75) Inventor: Andre Godin, Laval (CA)

Correspondence Address: ALEX NICOLAESCU;Ericsson Canada Inc., Patent Department (LMC/M/P), 8400 Decarie Blvd., Town Mount Royal, QC, H4P 2N2, CA

(73) Assignee: Telefonaktiebolaget L M Ericsson (publ)

(21) Appl. No.: 10/722,475

(22) Filed: Nov. 28, 2003

(51) Int. Cl. G06F 15/173

(52) U.S. Cl. 709/223

(57) ABSTRACT

A method and Graphical User Interface (GUI) for viewing and editing attribute values of Managed Objects (MOs) representative of Network Elements (NEs) and NEs components of a managed network that use different versions of Management Object Model (MOM). An administrator selects one or more MOs from a list of MOs and the GUI displays the attribute values for each selected MO based on the MOM version information relative to the NEs that corresponds to the selected MOs. The administrator further edits one or more attribute values of one or more MO, which may include editing a first value of an MO, and then copying it to other MOs. The copied value is adapted to the MOM version used by the target MO(s), and then displayed on the GUI. Finally, the administrator issues a command, and the updated values are translated into commands understandable by the appropriate NEs, which received the commands.

### BACKGROUND OF THE INVENTION

1. Field of the Invention

The present invention relates to a method and to a Graphical User Interface (GUI) for viewing and editing multiple Managed Objects (MOs) of a management system.

2. Description of the Related Art

Management systems are well known in the art. They are used for monitoring and managing the quality of communications over various networks, such as for example Local Area Networks (LANs), Wide Area Networks (WANs), Public Local Mobile Networks (PLMNs), and Public Switching Telephone Networks (PSTNs), hereinafter designated as the managed or monitored networks. Exemplary functions of a typical management system comprise, but are not limited to, providing information about Network Elements (NEs) or NEs' components' configuration and status, collecting alarm/event notifications, correlating alarm/event notifications, diagnosing and repairing errors and malfunctions. In such systems, pieces of information called events (or event notifications or alarms) are issued by the managed network and acquired by the management system, which is responsible of the treatment of the management information. Such information may be monitored, either automatically or by system administrators, with the general purpose of maintaining or increasing the quality of the communications of the managed network.

Reference is now made to FIG. 1 (Prior Art), which is a high-level network diagram of a management system 100 which function is to monitors a Public Local Mobile Network (PLMN) 102. The PLMN 102 may comprise, as it is well known in the art, a plurality of base stations 104-107, which provide cellular radio service to a plurality of mobile stations 108-119 via associated radio interfaces. The base stations 104-107 are connected to a Base Station Controller 1 (BSC 1) 120, which in turn connects to a Mobile Switching Center 1 (MSC 1) 122. The PLMN 102 may further comprise a second MSC, called MSC 2 124, and a second BSC, called BSC 2 126, as well as a Gateway GPRS Support Node (GGSN) 127, a Serving GPRS Support Node (SGSN) 128 and an associated Base Station Subsystem (BSS) 130. According to the exemplary PLMN 102 shown in FIG. 1, each Network Element (NE) of the PLMN, comprises an Agent (Agent 1 to Agent 7) responsible for maintaining management information about its corresponding NE. The management information of each agent may comprise configuration and status information about the particular NE and its components and connections. Each such NE agent connects via management links 111 (shown in double line) to a managed information Manager 160 of the management system 100, which function is to collect management information 150,152, and 154 issued by the NEs' agents 1-7 121,123,127, 125, 129, 131, and 133 of the managed system 102. The Manager 140 receives the management information 150, 152, and 154 from the monitored system 102 and may further process, correlate, and adapt the received management information into a format compatible and suitable for viewing by a variety of system administrators terminals 162-168 of the management system 100.

In a typical management system, the management information displayed on system administrators' terminals 162-168 comprises virtual entities known as Managed Objects (MOs), which are the virtual representations of Network Elements (NEs), or NEs' components of the managed system. For example, the BSC 1 120 is represented on the system administrators' terminal 162 as an MO. Further, the NE BSC 1 120 may comprise a plurality of NE components, such as for example radio controllers 170-179, which are also represented on the administrator's terminals 162 as a corresponding plurality of MOs 170′ 179′.

Such a virtual representation of each NE and NE component of the monitored network 102 allows system administrators of terminals 162-168 to be able to view ad edit the related attributes of each MO, and by this means to be able to monitor and improve the quality of the communications of the monitored network 102.

Reference is now made to FIG. 2 (Prior Art), which shows a typical Graphical User Interface (GUI) 200 of the system administrator's terminals 162 used for viewing and editing attributes of the various MOs. The GUI 200 may comprise a first GUI portion 210 on which a certain MO can be selected, such as for example the BSC 1 MO 120′ that corresponds to the NE BSC 1 120 of FIG. 1. Also shown on the GUI portion 210 are MOs 172′-179′ associated with the NE components 172-179 which are also better shown in FIG. 1. When a system administrator selects one of the MOs illustrated on the GUI portion 210, such as for example the MO C1 120′, a list of attributes associated with the selected MO is displayed on a second GUI portion 212. The second GUI portion 212 comprises a sub-portion that displays an identity of the selected managed object, which in the present exemplary scenario is the MO C-1 172′. The second GUI portion 212 further comprises another sub-portion that displays a list of attributes (Attr. 1-5) 220-228 of the selected MO C1 172′, with their respective attribute values 230-238.

As it can be seen from FIG. 2, a system administrator who desires to view and edit MO attributes related to a certain NE or component, such as for example related to the NE component Cl 120′, can select the targeted MO, and can view or edit its associated attribute values 230-238. If identical attribute values must be entered for more than one component, such as for example for fifty (50) different components of the managed network, the system administrator in charge must sequentially select each associated MO of the targeted fifty (50) components individually, and alter the required attribute values fifty (50) different times.

In a typical managed network, the number of monitored NEs can be significant and therefore viewing and especially editing attribute values of one MO at a time, as it is the case with existing prior art implementations, is frequently time-consuming.

The problem is further complicated when NEs of the monitored network use different versions of a Managed Object Model (MOM). The MOM designates the management protocol and/or the management application used for collecting and/or exchanging management information between the managed network and the Manager 160. This results in different types of management information being sent to the management system. Viewing management information that originates from NEs using different MOMs, and especially editing management information that can take different formats depending upon the supported version, is cumbersome and sometimes even unmanageable.

Although there is no prior art solution as the one proposed hereinafter for solving the above-mentioned deficiencies, the International Patent Application Number WO 03/007549 bears some relation with the field of the present invention. In this publication, there is taught a method for controlling a private or a public communications system using interconnected MOs, which are visualized to users or administrative personnel in at least one dimension, in at least one view, and in at least one window through a GUI. The disclosed method comprises the steps of displaying the MOs of the communications system in the first view as elements of a map, which comprises a structure with branches for every distinct group of elements or distinct elements in a hierarchical flow. The publication 03/007549 also teaches a table view in which multiple MOs can be displayed and which settings can be altered by a system administrator.

However, the teaching of the publication 03/007549 is limited to a table view wherein only settings of MOs that relate to individual NEs can be viewed and altered. The present publication fails to teach or suggest displaying or editing MOs that relate to NE components, as it fails to teach or suggest concomitantly displaying and editing attributes of components that belong to different NEs. The publication conclusively also fails to teach or suggest displaying and editing MO attributes related to NEs that run with different MOM versions.

Accordingly, it should be readily appreciated that in order to overcome the deficiencies and shortcomings of the existing solutions, it would be advantageous to have a method and system for effectively allowing the display and editing of MOs related to various NEs and components of NEs, which may run with different MOM versions. The present invention provides such a method and system.

### SUMMARY OF THE INVENTION

In one aspect, the present invention is a method for changing attribute values of a plurality of Managed Objects (MO) using a Graphical User Interface (GUI), the method comprising the steps of:
a. changing at least one attribute value of at least one MO from the plurality of MOs;
b. initiating a copy of the at least one attribute value to at least one other MO from the plurality of MOs;
c. adapting the at least one attribute value to be copied based on a Managed Object Model (MOM) version information relative to the at least one other MO from the plurality of MOs to which the at least one attribute value is to be copied; and
d. displaying an adapted attribute value for the at least one other MO.

In another aspect, the present invention is a Graphical User Interface (GUI) system comprising:
a memory storing a data structure comprising of a plurality of MOs that are representative of Network Elements (NEs);
a GUI allowing for a viewing and an editing of attributes values related to the MOs; and
a processor in communication with the memory and the GUI;
wherein responsive to i) a change of at least one attribute value of at least one MO from the plurality of MOs displayed on the GUI and ii) an initiation of a copy of the at least one attribute value to at least one other MO from the plurality of MOs, the processor adapts the at least one attribute value to be copied based on Management Object Model (MOM) version information relative to the at least one other MO from the plurality of MOs to which the at least one attribute value is to be copied, and the GUI displays an adapted attribute value for the at least one other MO.

In yet another aspect, the present invention is a Graphical User Interface allowing for a viewing and an editing of attributes values related to Managed Objects (MO) displayed on the GUI, the GUI acting responsive to i) a change of at least one attribute value of at least one MO from the plurality of MOs displayed on the GUI, and ii) an initiation of a copy of the at least one attribute value to at least one other MO from the plurality of MOs, to display an adapted attribute value for the at least one other MO, wherein the adapted attribute value is adapted based on Management Object Model (MOM) version information relative to the at least one other MO from the plurality of MOs to which the at least one attribute value is to be copied.

### BRIEF DESCRIPTION OF THE DRAWINGS

For a more detailed understanding of the invention, for further objects and advantages thereof, reference can now be made to the following description, taken in conjunction with the accompanying drawings, in which:

FIG. 1 (Prior Art) is a high-level network diagram of a typical management system that monitors a Public Local Mobile Network (PLMN);

FIG. 2 (Prior Art) is typical Graphical User Interface (GUI) for viewing and editing attributes of a Managed Object (MO) corresponding to a Network Element (NE);

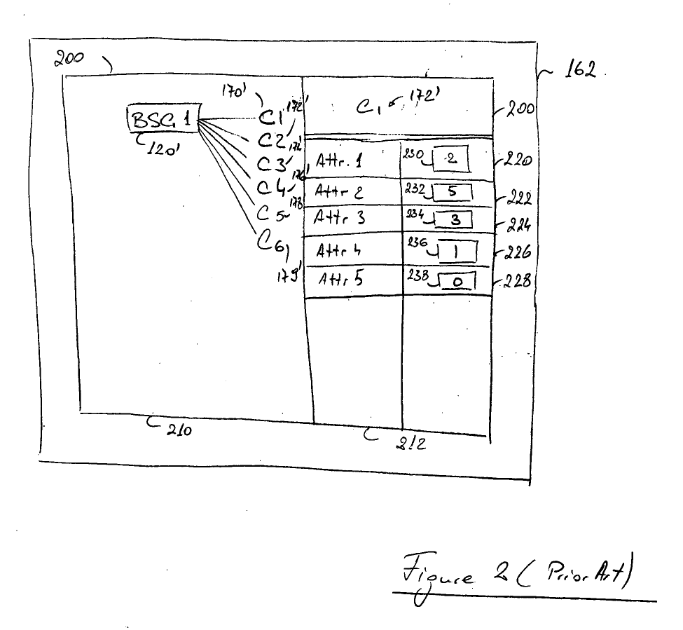

FIG. 3 is a GUI for viewing and editing attributes of MOs related to NEs or NEs components according to the preferred embodiment of the present invention; and

FIG. 4 is an exemplary flowchart diagram of a method for viewing and editing attributes of the MOs related to NEs or NEs components according to the preferred embodiment of the present invention.

### DETAILED DESCRIPTION OF THE PREFERRED EMBODIMENTS

The innovative teachings of the present invention will be described with particular reference to various exemplary embodiments. However, it should be understood that this class of embodiments provides only a few examples of the many advantageous uses of the innovative teachings of the invention. In general, statements made in the specification of the present application do not necessarily limit any of the various claimed aspects of the present invention. Moreover, some statements may apply to some inventive features but not to others. In the drawings, like or similar elements are designated with identical reference numerals throughout the several views.

The present invention provides a method and a Graphical User Interface (GUI) allowing for the convenient viewing and editing of Managed Objects (MO) of various kinds, including MOs that correspond to Network Elements (NEs) and MOs that correspond to components of one or more NEs. The present invention also allows for the viewing and editing of MOs related to NEs that run with different Managed Object Model (MOM) versions.

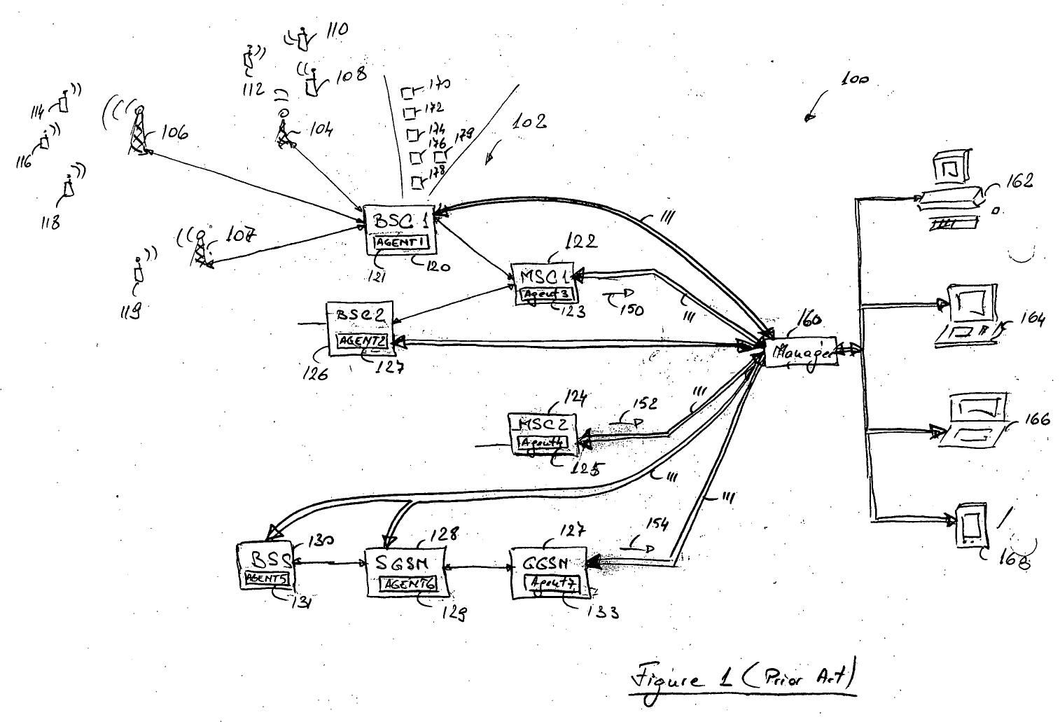

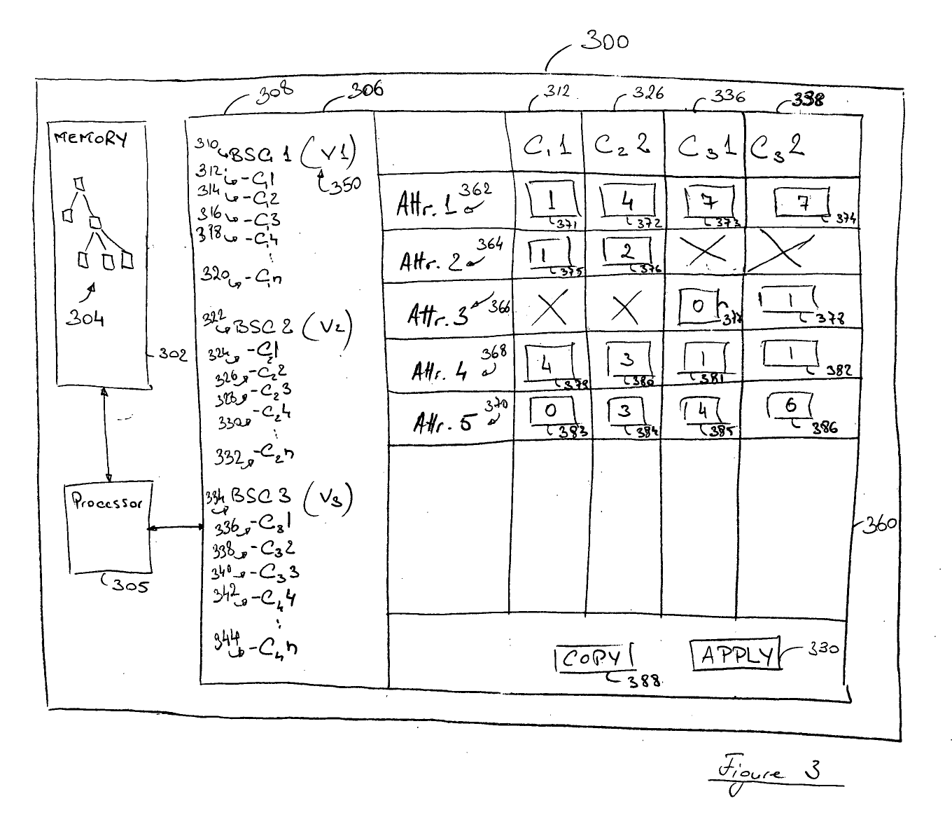

Reference is now made to FIG. 3, which shows a GUI for viewing and editing attributes of MOs representative of NEs or NEs components according to the preferred embodiment of the present invention. Shown in FIG. 3, is first a network administrator's terminal 300 comprising a memory 302 that stores a management information data structure 304 that is representative of network configuration and status information related to a managed network, which may be similar to the managed network 102 previously described with reference to FIG. 1. The network administrator's terminal 300 further comprises a processor 305 that retrieves and processes information relative to MOs from the data structure 304 of the memory 302, and sends this information to the GUI 306 for being displayed. The functions of the GUI 306 include displaying and editing attributes related to MOs representative of NEs and/or NEs' components. Specifically, the GUI 306 may comprise a first portion 308 for displaying a list of MOs 310-344, among which a first part are representative of NEs of the monitored network, such as for example of nodes such as the BSC 1, BSC 2, and BSC 3 (MOs 310, 322, and 334), while a second part of the shown MOs are representative of NE components, such as for example C₁1 C₁2, C₁3, C₁4 . . . Cₐn, C₂1, C₂2, C₂3, C₂4 . . . C₂n, C₃1, C₃2, C₃3, C₃4 . . . C₃n (MOs 312-320, 324-332, and 336-344). The MOs that correspond to a certain NE of the managed network and that are displayed in the GUI portion 308 may also contain information relative to a certain MOM version used by the certain NE. For example, the MOs 310-320 all relate to the NE BSC 1 and are said to use MOM version V1 350. Likewise, other MOs relative to another NE may comprise different MOM versioning information. The versioning information is retrieved by the processor 305 from the same data structure 304 of the memory 302 and sent along with the MOs related information to the GUI 306 for being displayed.

The GUI 306 further comprises a second portion 360 for displaying and editing MO attributes 362-370 relative to certain selected MOs. A user of the terminal 300 may use the first portion of the GUI 306 to first select for viewing and/or editing one or more MOs from the list of available MOs 310-344, using, for instance, a pointing device such as a mouse. According to the present exemplary scenario, the user may select for viewing and editing the MO C₁1 312, MO C₂2 326, MO C₃1 336, and MO C₃2 338. Upon selection by the user of the desired MOs in the first GUI portion 308, the second GUI portion 360 displays values 371-386 of each attribute of the selected MOs, also based on the MOM versioning information associated with each one of the selected MOs 312, 326, 336, and 338. The attributes' values 371-386 are retrieved by the processor 305 from the data structure 304 of the memory 302 of the terminal 300 and sent for displaying on the GUI 306, or may alternatively be retrieved by the processor 305 from a node external to the terminal 306 (node not shown in FIG. 3). The GUI portion 360 displays the attribute's values 371-386 based on MOM versioning information available for each MO. For example, in the present exemplary scenario, the MO C₁1 312 uses MOM version V1 350, since that MO is representative of a NE component of the BSC 1, which MOM versioning information relates to MOM version V1 350. MOM version V1 350 does not support attribute 3 366, and hence no value is represented in the column associated with MO C₁1 312 for that attribute. Likewise, the MO C₂2 326 is representative of a component that belongs to the NE BSC 2, which uses another MOM version V2, which again does not support attribute 3 366. Finally, MOs C₃1 336 and C₃2 338 are representative of components that belong to NE BSC 3 that uses MOM version V3. This MOM version does not support attribute 2 364, which value is therefore not represented in GUI portion 360.

Once the attributes values of the selected MOs are displayed in the second GUI portion 360, the user may desire to update one or more of such attributes values. The reason for the editing may include changing parameters associated with the managed network, correcting a detected malfunction in the NE represented by a given MO, testing, fine-tuning a certain parameter, etc. For proceeding with the update, the user may select one or more attribute values of one or more of the displayed MOs, and edit its/their associated value(s). The data entry for a certain attribute value may be performed individually, i.e. selecting one attribute value at a time and editing it. Alternatively, in certain instances, the user may desire to edit all the values of a given type of attribute, such as for example all the values of attribute type 1 362, which values relate in the present exemplary scenario to the selected MOs 312, 326, 336, and 338. In order to edit these attribute values and set them all to the same value, the user may enter the desired new attribute value 371 for only one of the selected MOs, such as for example for MO 312, and then copy that value to the entire row, i.e. to all the other selected MOs, by using a copy button 388. As a result, the attribute value 371 is copied to, and replaces the old attribute values 372, 373, and 374. In the present exemplary scenario, MO 312 is representative of a component of an NE using MOM version V1, as it is shown in the first GUI portion 308, while MO 326 is representative of a component of an NE using MOM version V2. Therefore, when the action of copying the attribute value “1” 371 is performed, a translation of the value “1” 371 is made toward the MOM version V2, and the original value “1” 371 is translated into the corresponding value “4” 372 of the target MOM version, which value represents the same parameter and has the same meaning in the MOM version V2.

Likewise, since the MOs 336 and 338 are representative of components of the NE BSC 3 that uses MOM version V3, when the action of copying the attribute value “1” 371 is made, a translation is made toward the MOM version V3, and the original value “1” 371 is translated into the corresponding value of the target MOM version, which in the present case is the value “7” 373 and 374. This value represents the same parameter and has the same meaning in MOM version V3 as the original value “1” 371 in the MOM version V2.

The translation is performed only if required, i.e. if the source MOM version and the target MOM version use different attribute values for similar representations of a given attribute type.

After the user has proceeded to all the desired updates of the attributes' values, he may press an apply button 390 for deploying the updates toward the NEs and NE components represented by the selected MOs 312, 326, 336, and 338 which values have been changed. Upon activation of the apply button 390, the processor 305 retrieves the updated information from the GUI portion 360, updates the data structure 304 of the memory 302 accordingly, and further sends update commands for modifying the parameters of the NEs and NE components that are represented by the selected MOs 312, 326, 336, and 338 which attributes values have been changed. The processor 305 may also use the available MOM versioning information relative to each selected MO in order to translate the updated attributes values into commands compliant with the MOM version used by each corresponding NE or NE component. For example, assuming that an attribute value relative to the MO C₁1 312 has been modified, when activating the apply button 390, the processor 305 detects that that MOs' attributes have been modified, and translates the modified attribute value into a command understandable by the MOM version V1 350 which is used by the NE BSC 1 that “owns” the NE component corresponding to the modified MO.

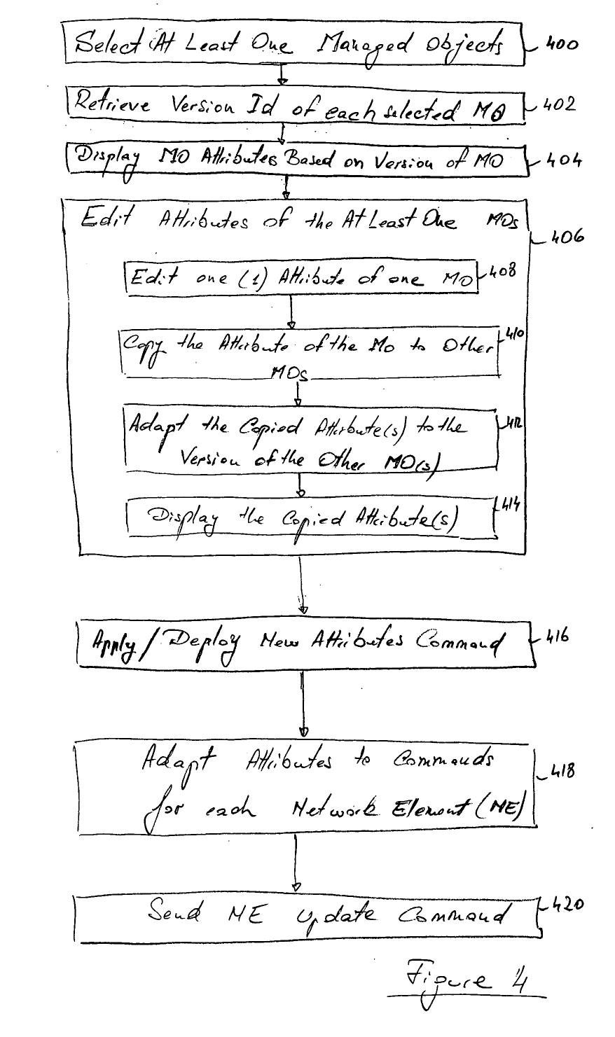

Reference is now made to FIG. 4, which is an exemplary flowchart diagram of the method for viewing and editing attributes of the MOs related to NEs or NE components according to the preferred embodiment of the present invention. The method of FIG. 4 starts when the user selects one or more MOs for viewing and/or editing, action 400, as described hereinbefore with reference to FIG. 3. Once the desired MOs are selected, the processor retrieves MOM versioning information relative to each one of the selected MOs, action 402, and in action 404, the MO attributes values are displayed on the GUI, action 404. Action 404 may comprise displaying the attribute values of the selected MOs based on the MOM version of the selected MOs, i.e. only displaying those attributes of the selected MOs that are supported by the MOM application version related to each MO. In action 406, the user may edit the attributes values of one or more MOs. Action 406 may include editing one attribute values of a certain MO, action 408, and copying the new attribute value to one or more other MOs, action 410. Responsive to the copy command of action 410, the attribute value to be copied is translated, if required, for each target MO, into the proper attribute value based on the supported MOM version of that MO, action 412, and in action 414 the translated attribute values are displayed on the GUI.

Once the desired updates are performed on the attribute values of the selected MOs, the user may press an apply button for deploying the attribute values updates into the managed network, action 416. Responsive to the apply command, in action 418 the processor translates the updated attributes values into commands understandable by each NE that relates to the MOs which attributes values have been updated, action 418. These commands are send toward the appropriate NEs that correspond to the MOs updated using the GUI, action 420.

Therefore, with the present invention it becomes possible to easily edit multiple attributes values of MOs that are representative of NEs or NE components when these NEs are managed with different versions of MOM.

Based upon the foregoing, it should now be apparent to those of ordinary skills in the art that the present invention provides an advantageous solution, which offers a GUI and a method for viewing and editing multiple managed objects attribute values in a managed network with network elements that use multiple versions of MOM, including multiple management protocols. It should be realized upon reference hereto that the innovative teachings contained herein may be implemented advantageously with any applicable radio telecommunications standard for a monitored network. It is believed that the operation and construction of the present invention will be apparent from the foregoing description. While the method and system shown and described have been characterized as being preferred, it will be readily apparent that various changes and modifications could be made therein without departing from the scope of the invention as defined by the claims set forth hereinbelow.

Although several preferred embodiments of the method and system of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

1. A method for changing attribute values of a plurality of Managed Objects (MO) using a Graphical User Interface (GUI), the method comprising the steps of:
a. changing at least one attribute value of at least one MO from the plurality of MOs;
b. initiating a copy of the at least one attribute value to at least one other MO from the plurality of MOs;
c. adapting the at least one attribute value to be copied based on a Managed Object Model (MOM) version information relative to the at least one other MO to which the at least one attribute value is to be copied; and
d. displaying an adapted attribute value for the at least one other MO.

2. The method claimed in claim 1 further comprising, prior to step a., the step of:
e. displaying on the GUI the attribute values of the plurality of MOs.

3. The method claimed in claim 2, wherein the plurality of MOs are MOs selected by a user, and the method comprises prior to step e., the step of:
f. retrieving MOM version information relative to each MO from the plurality of MOs;
wherein the step e. comprises displaying on the GUI the attribute values of the plurality of MOs based on the retrieved MOM version information relative to each MO from the plurality of MOs, wherein only attributes values that are supported by a given MOM version of a given MO are displayed on the GUI for the given MO.

4. The method of claim 1 further comprising the steps of:
e. instructing an apply command for deploying the adapted attribute value relative to the at least one other MO to a corresponding Network Element (NE);
f. translating the adapted attribute value relative to the at least one other MO into a command understandable by the corresponding NE; and
g. sending the command understandable by the corresponding NE to the corresponding NE.

5. A Graphical User Interface (GUI) system comprising:
a memory storing a data structure comprising of a plurality of MOs that are representative of Network Elements (NEs);
a GUI allowing for a viewing and an editing of attributes values related to the MOs; and
a processor in communication with the memory and the GUI;
wherein responsive to i) a change of at least one attribute value of at least one MO from the plurality of MOs displayed on the GUI and ii) an initiation of a copy of the at least one attribute value to at least one other MO from the plurality of MOs, the processor adapts the at least one attribute value to be copied based on Management Object Model (MOM) version information relative to the at least one other MO from the plurality of MOs to which the at least one attribute value is to be copied, and the GUI displays an adapted attribute value for the at least one other MO.

6. The GUI system claimed in claim 5 wherein the attribute values of the plurality of MOs are initially displayed on the GUI.

7. The GUI system claimed in claim 6, wherein the plurality of MOs are MOs selected by a user, and the processor retrieves from the memory MOM version information relative to each MO from the plurality of MOs;
wherein the GUI displays the attribute values of the plurality of MOs based on the retrieved MOM version information relative to each MO from the plurality of MOs, wherein only attributes values that are supported by a given MOM version of a given MO are displayed on the GUI for the given MO.

8. The GUI system of claim 5 wherein responsive to an apply command for deploying the adapted attribute value relative to the at least one other MO to a corresponding Network Element (NE), the processor translates the adapted attribute value relative to the at least one other MO into a command understandable by the corresponding NE, and sends the command understandable by the corresponding NE to the corresponding NE.

9. A Graphical User Interface allowing for a viewing and an editing of attributes values related to Managed Objects (MO) displayed on the GUI, the GUI acting responsive to i) a change of at least one attribute value of at least one MO from the plurality of MOs displayed on the GUI, and ii) an initiation of a copy of the at least one attribute value to at least one other MO from the plurality of MOs, to display an adapted attribute value for the at least one other MO, wherein the adapted attribute value is adapted based on Management Object Model (MOM) version information relative to the at least one other MO from the plurality of MOs to which the at least one attribute value is to be copied.

10. The GUI claimed in claim 9 wherein the GUI initially displays the attribute values of the plurality of MOs.

11. The GUI claimed in claim 9, wherein the plurality of MOs are MOs selected by a user from a list of MOs displayed by the GUI, wherein the GUI displays the attribute values of the plurality of MOs based on MOM version information relative to each MO from the plurality of MOs, wherein only attributes values that are supported by a given MOM version of a given MO are displayed on the GUI for the given MO.
